(19) United States
(12) Patent Application Publication
(10) Pub. No.: US 2014/0196530 A1
(43) Pub. Date: Jul. 17, 2014

(54) Tyre Pressure Monitor

(71) Applicant: Stephen John WEBSTER, Berwick (AU)

(72) Inventor: Stephen John WEBSTER, Berwick (AU)

(73) Assignee: Castaa Enterprises Pty Ltd., Berwick (AU)

(21) Appl. No.: 13/741,219

(22) Filed: Jan. 14, 2013

(51) Int. Cl. B60C 23/04

(52) U.S. Cl. CPC B60C 23/04
USPC 73/146.3

(57) ABSTRACT

A tyre pressure monitor for the paired wheels at one end of a vehicle axle in the form of a hub which bolts to the wheel using the wheel nuts. The hub contains a tyre pressure gauge for the inner wheel and a gauge for the outer wheel. Air tubes connect each tyre to the gauge and an exterior air input coupling for each tyre projects from the hub in order to be accessible to the depot air hose. The driver reads the gauge and adjusts the tyre pressure using the air input coupling when necessary. Versions with a single gauge with a separate scale for each tyre of the pair and with one gauge for a single front wheel are described.

### TECHNICAL FIELD

This invention concerns apparatus for monitoring and adjusting tyre pressure in trucks and trailers.

### BACKGROUND

Tyre manufacturers supply pressure data for their products and recommend optimum pressures for operational safety and mileage. Shortfalls in the expected life of tyres are a serious matter for a trucking company. Regulations imposed by authorities and policy conditions maintained by insurance companies underline the importance of keeping the tyre pressures in trucks and trailers at the recommended levels. While drivers are aware of the requirements, in practice a daily check before leaving the depot is onerous, moreover companies are unwilling to pay the driver to perform routine checks when the driver could be in the cab reducing the work load on the company.

To minimise the frequency of the checks made by the driver, a variety of monitoring systems are available. These are installed in the cab or trailer and indicate if a safety threshold is approaching. In order to increase tyre pressures the depot air line which delivers 100-110 psi must be moved across the ground to the single steered front wheels, the tyre inflated and the final pressure of 100 psi confirmed. The air line is brought to the outer tyres and then through a wheel gap to the inner tyre. It is the latter which are time consuming and requires the most agility.

In addition if a driver maintenance checklist must be completed by supplying numbers for the individual tyre pressures the check becomes expensive in terms of employee time. In practice experienced drivers strike each tyre with a rod and estimate from the note of the impact whether the tyre requires inflation. The accuracy of such a procedure is variable and can at best be only a guide. Persistent under-inflation causes scalloping in the tyre tread and a shortfall in the operational life of the tyre.

### SUMMARY OF INVENTION

A tyre pressure monitor for the paired wheels at one end of a vehicle axle, comprising a body attachable to the outer wheel of the pair, a pressure gauge accommodated by the body for the tyre of the outer wheel, a pressure gauge accommodated by the body for the tyre of the inner wheel, an accessible air conduit projecting from the body which is connected to the gauge and is connectable to the outer wheel tyre, an accessible air conduit projecting from the body which is connected to the outer gauge and is connectable to the inner wheel tyre.

The body may be a cylindrical chamber surrounded at one end by a flange for overlying the wheel nuts. The body may be formed as a shell with an end wall. A pair of apertures in the end wall may receive the gauges enabling them to be read simultaneously.

The projecting end of the air conduit is adapted to receive the self sealing coupling of the air hose. The opposite end of the air conduit has a threaded coupling for connection to the tyre valve of the wheel.

The gauges may be marked FRONT and REAR or INNER and OUTER in order to indicate to the driver which tyre is being checked. If one tyre is punctured, the driver can tell which one it is.

The invention also provides a version of the monitor adapted for a single wheel comprising a body, a single gauge and a single air inlet. Single wheels are fitted to some trailers. The steerable wheels of trucks and prime movers are single wheels and it is for these instances that the adaptation is intended.

In this specification “hub” means any housing or bracket which is capable of presenting a gauge in a position readable by a driver and presenting accessible air inlets for the compressor hose.

### BRIEF DESCRIPTION OF DRAWINGS

One embodiment of the invention is now described with reference to the accompanying drawings, in which:

FIG. 1 is a plan of the hub with twin gauges intended for a wheel pair.

FIG. 2 is a section through the hub of FIG. 1 when fitted to half a bogie being part of a truck.

FIG. 3 is a side view of the hub of FIG. 1.

FIG. 4 is a sectional end view of the hub of FIG. 1.

FIG. 5 is a sectional end view of the hub of FIG. 1 modified for a single wheel such as a steered front wheel.

FIG. 6 is a plan of a gauge with psi and KPa scales.

FIG. 7 is a section of a hub with a single gauge arranged to read both inner and outer tyres.

FIG. 8 is a perspective view of a variant in the form of a bracket.

FIG. 9 is a variant of the hub shown in FIG. 2.

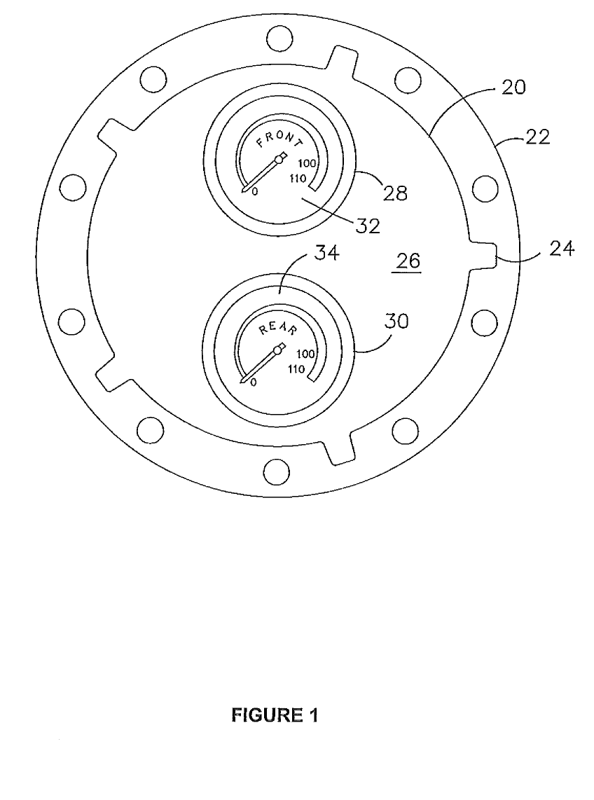

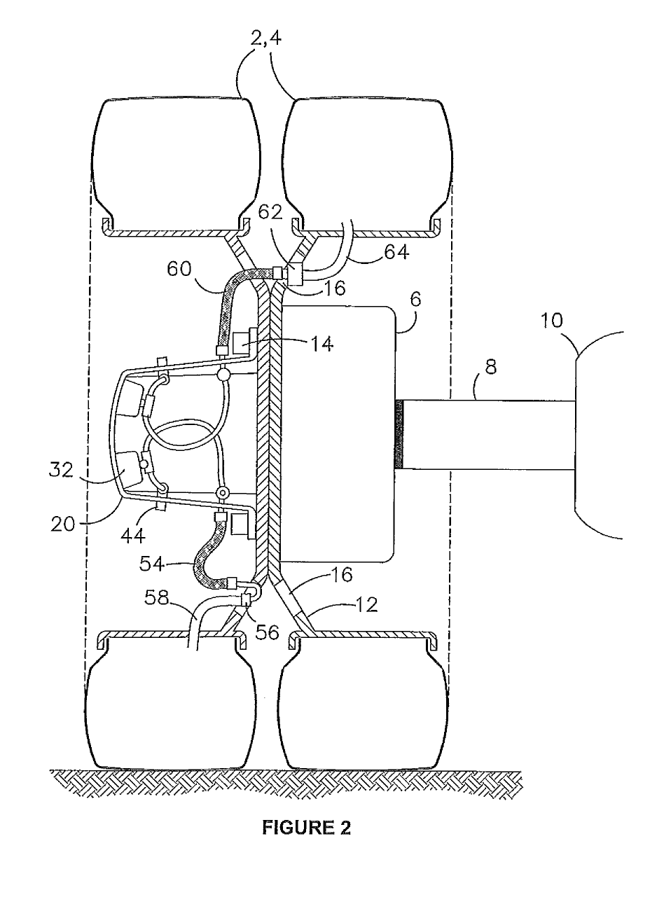

### DESCRIPTION OF EMBODIMENTS

Referring to the drawings, the hub is intended for the pairs of wheels composing a truck bogie of eight wheels which would require four hubs. Each pair of wheels 2, 4 is bolted to the studs of a brake assembly 6 which receives drive from shaft 8 and differential 10.

The steel wheels 12 are deeply concave and when the convex faces thereof come together the wheel nuts 14 form an inner ring and the wheel apertures 16 form an outer ring. The tyre valve tubes 18 normally engaged by the depot air hose (not shown) project through the apertures 16 and point towards each other.

The hub is a 2 mm thick substantially frusto conical steel housing 20 which is surrounded by a 340 mm annular flange 22 pierced by ten bores for the wheel studs.

The housing is 220 mm in dia standing 200 mm high and stiffened by five ribs 24. The exterior face is chrome plated. The end 26 is convex and extends the hub by 50 mm. The end has two circular apertures 28, 30 for the reception of a pair of tyre pressure gauges 32, 34, one marked FRONT, the other marked REAR. Paint is a satisfactory finish to the hub.

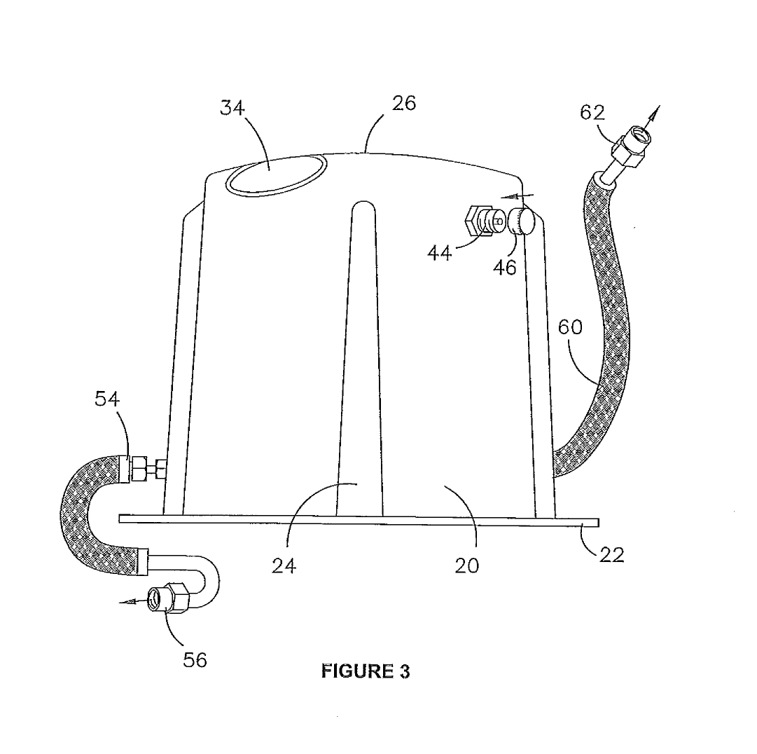

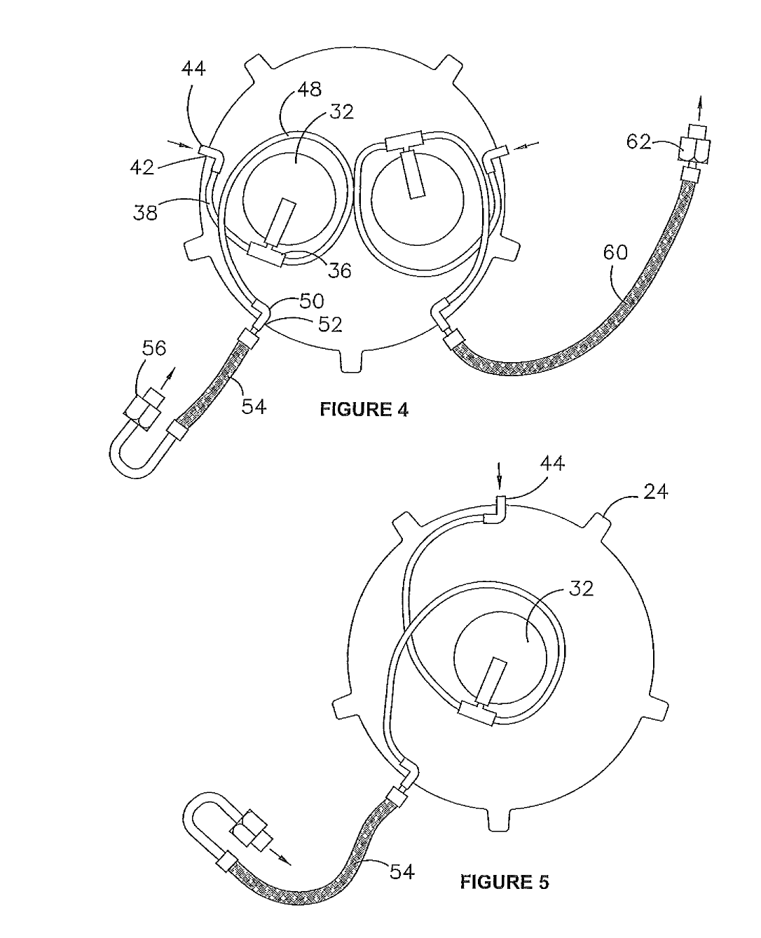

The FRONT gauge 32 is connected to a T-piece 36. One end of the T-piece is connected by a plastic air tube 38 to an elbow 40 which aligns with bore 42 in the housing wall. An exterior Schrader valve fitting 44 screws into the elbow and provides an input for the depot air hose. The exterior fitting is closed by a screw cap 46 (FIG. 3). The opposite end of the T-piece is connected by plastic air tube 48 to elbow 50 which aligns with a bore 52 in the housing wall. The ferrule of a hose fitting 54 screws into the elbow. The hose fitting 54 is 120 mm long and ends in a U-tube with a female cap 56 which screws onto the rearwardly pointing tyre valve 58.

The adjacent REAR gauge has duplicate fittings with the difference that the hose fitting 54 is replaced with a 300 mm air hose 60 which is capable of reaching through the outer wheel to the aperture 16 of the inner wheel where a female cap 62 screws on to tyre valve 64.

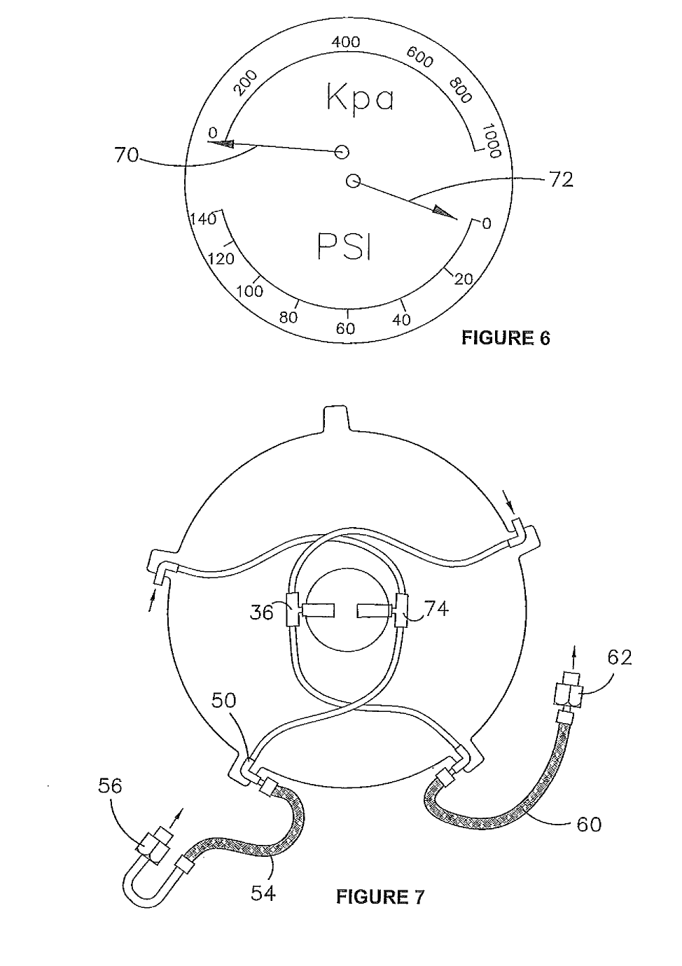

The gauges are mechanical in electrical or electronic operation and are unaffected by the rotation of the hub at the cruising speed of the truck. A gauge reading in psi and Kpa is shown in FIG. 6. A single gauge is used in a variant hub with two scales, two pointers and two sets of fittings leading to and from the gauge.

The hub is installed by unbolting wheel 2 to give access to the tyre valve 64. Conduit 60 is fed through a wheel aperture and wheel 2 is placed on the wheel studs of assembly 6. The hub is next placed on studs and the wheel nuts 14 tightened. Conduit 54 is attached to tyre valve 58.

When the drivers daily inspection begins, the depot air hose is connected to the tyre valve 44 and a reading on the FRONT gauge 32 is noted. The hose is disconnected and reconnected to the remaining air inlet for the rear wheel and the reading of REAR gauge 34 is noted. If either tyre requires inflation, the driver admits air and notes the raised reading. If the driver starts from a location without an air hose, for example at an overnight stop, it may be possible to utilise the air supply from the compressed air tank in the truck.

The steerable wheels (not shown) and any single trailer wheels are inflated using a variant of the hub shown in FIG. 5 except that a single inlet, gauge and coupling for connection to a tyre valve applies. Thus the hub is adaptable for both prime movers and trailers.

In FIG. 6 the psi scale is arranged over an arc different from the Kpa scale and a separate pointer 70, 72 give duplicate readings.

In FIG. 7 a single gauge 32 has two pointers which indicate on a FRONT scale and a REAR scale and for this purpose the gauge has a T-piece 36 for connection to the air tubes of the front tyre and a T-piece 74 for connection to the air tubes of the rear tyre.

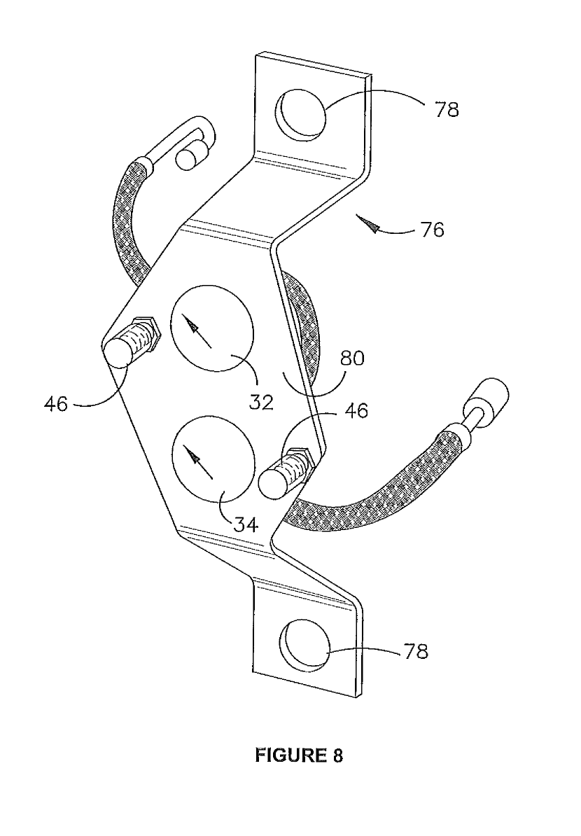

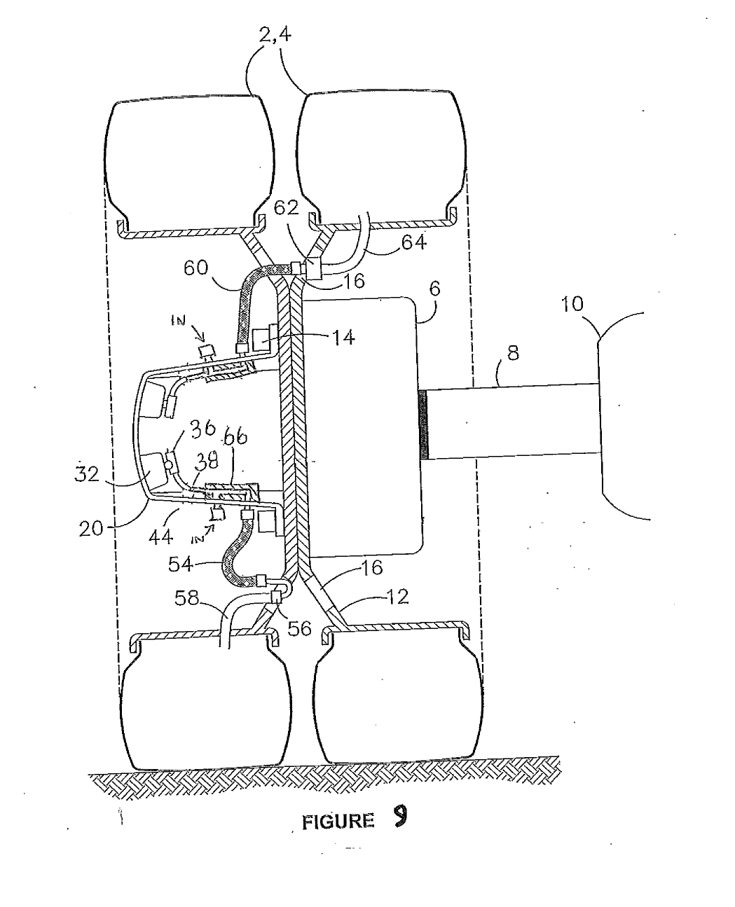

In FIG. 8 double bracket 76 has a pair of bores 78 for receiving diametrically opposite wheel studs. FRONT and REAR wheel gauges 32, 34 and air inlets 44 are mounted on the flat panel 80 of the bracket.

We have found the advantages of the above embodiments to be:

1. They provide incentive to drivers to adjust tyre pressures to the manufacturer's recommended pressure.

2. The tyres reach the advertised mileage with consequent financial savings.

3. Road safety improves.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1. A tyre pressure monitor for the paired wheels at one end of a vehicle axle, comprising a hollow hub attachable to the outer wheel of the pair, a pressure gauge accommodated by the hub for the tyre of the outer wheel, a pressure gauge accommodated by the hub for the tyre of the inner wheel, a first conduit partially inside the hub and partially outside the hub, an air input coupling connected to one end of the first conduit and an air output coupling at the opposite end for connection to a tyre valve of the inner wheel and a branch of the first air conduit connected to the inner gauge, a second air conduit partially inside the body and partially outside the body, an air input coupling connected to one end of the second conduit and an air output coupling at the opposite end for connection to a tyre valve of the outer wheel and a branch of the second air conduit connected to the outer gauge.

2. A tyre pressure monitor as claimed in claim 1, wherein the body is a cylindrical chamber surrounded at one end by a flange for overlying the wheel studs.

3. A tyre pressure monitor as claimed in claim 2, wherein the chamber is formed as a shell with an end wall.

4. A tyre pressure monitor as claimed in claim 3, wherein the gauges are mounted in the end wall so as to be readable by a person standing next to the wheel.

5. A tyre pressure monitor as claimed in claim 1, wherein the projecting end of the air conduit is adapted to receive the nozzle of the compressor air line.

6. A tyre pressure monitor as claimed in claim 5, wherein the projecting end of the air conduit is a self sealing coupling operable to receive an extender which itself receives the nozzle of the compressor air line.

7. A tyre pressure monitor as claimed in claim 6, wherein the extender is an U-shaped tubular fitting.

8. A tyre pressure monitor for the paired wheels at one end of a vehicle axle, comprising a hollow hub attachable to the outer wheel of the pair, a pressure gauge accommodated by the hub for the tyre of the outer wheel, a pressure gauge accommodated by the hub for the tyre of the inner wheel, a first air conduit with a portion inside the hub and a portion outside the hub, an air input coupling connected by the inner portion to the gauge and also connected by the outside portion to the air outlet coupling for connection to a tyre valve of the outer wheel, and a second air conduit with a portion inside the hub and a portion outside the hub, an air input coupling connected by the inner portion to the inner gauge and also connected by the outside portion to an air outlet coupling for connection to a tyre valve of the inner wheel.

9. A tyre pressure monitor as claimed in claim 8, wherein the body is a cylindrical chamber surrounded at one end by a flange for overlying the wheel studs.

10. A tyre pressure monitor as claimed in claim 9, wherein the chamber is formed as a shell with an end wall.

11. A tyre pressure monitor as claimed in claim 10, wherein the gauges are mounted in the end wall so as to be readable by a person standing next to the wheel.

12. A tyre pressure monitor as claimed in claim 8, wherein the projecting end of the air conduit is adapted to receive the nozzle of the compressor air line.

13. A tyre pressure monitor as claimed in claim 12, wherein the projecting end of the air conduit is a self sealing coupling operable to receive an extender which itself receives the nozzle of the compressor air line.

14. A tyre pressure monitor as claimed in claim 13, wherein the extender is an U-shaped tubular fitting.

15. A tyre pressure monitor for truck tyres comprising a hollow hub attachable to the wheel, a pressure gauge accommodated by the hub, an air conduit partly with the body, an external air input coupling at one end of the conduit, an external coupling for the tyre valve at the opposite end, and a branch of the air conduit connected to the pressure gauge.

16. A tyre pressure monitor for the paired wheels at one end of a vehicle axle, comprising a hollow hub attachable to the outer wheel of the pair, a pressure gauge accommodated by the hub operable to read both tyre pressures, a first air conduit partially inside the hub and partially outside the hub, an air input coupling connected to one end of the first conduit and an air output coupling at the opposite end for connection to the tyre of the inner wheel and a branch of the first air conduit connected to the gauge, a second air conduit partially inside the body and partially outside the body, an air input coupling connected to one end of the second conduit and an air output coupling at the opposite end for connection to the tyre valve of the outer wheel and a branch of the second conduit connected to the same gauge.
